(19) United States
(12) Patent Application Publication
(10) Pub. No.: US 2019/0166358 A1
(43) Pub. Date: May 30, 2019

(54) DISPLAY DEVICE, ELECTRONIC MIRROR AND METHOD FOR CONTROLLING DISPLAY DEVICE

(71) Applicant: SHARP KABUSHIKI KAISHA, Sakai City (JP)

(72) Inventors: Takehiko NAKAGAWA, Sakai City (JP); Yoshimitsu INAMORI, Sakai City (JP); Eri YANAGAWA, Sakai City (JP); Takehiro MURAO, Sakai City (JP); Ryoh KIKUCHI, Sakai City (JP); Takayuki YAMADA, Sakai City (JP)

(21) Appl. No.: 16/203,347

(22) Filed: Nov. 28, 2018

(30) Foreign Application Priority Data
Nov. 30, 2017 (JP) 2017-230811

(51) Int. Cl. H04N 13/359; G06T 19/00; G09G 3/00; H04N 13/31; H04N 13/366; G06F 3/01; B60R 1/00

(52) U.S. Cl. CPC H04N 13/359; G06T 19/006; G09G 3/001; B60R 1/00; H04N 13/366; G06F 3/013; H04N 13/31

(57) ABSTRACT

An aspect of the present invention provides a display device that does not hinder driving. An electronic mirror includes: an image display device capable of switching between 2D display and 3D display, the 3D display being carried out by a parallax barrier method; and a distance measuring device for measuring a distance from eyes of a user to a display screen of the image display device. The electronic mirror switches display from the 3D display to the 2D display in a case where the distance measured by the distance measuring device falls outside a predetermined range during the 3D display.

This Nonprovisional application claims priority under 35 U.S.C. § 119 on Patent Application No. 2017-230811 filed in Japan on Nov. 30, 2017, the entire contents of which are hereby incorporated by reference.

### TECHNICAL FIELD

The present invention relates to a display device and an electronic mirror each capable of switching between 3D display in which a 3D image (stereoscopic image) is displayed and 2D display in which a 2D image (planar image) is displayed.

### BACKGROUND ART

In recent years, there have been developed vehicles in each of which an image around the vehicle is captured by a camera mounted on the vehicle and the image thus captured is displayed on a display screen provided in front of a driver. A combination of the camera and the display screen is called an electronic mirror. Examples of the electronic mirror include a back display screen which displays an image just behind a vehicle. Further, the electronic mirror is used as a substitute for a room mirror or a door mirror (side mirror).

Among electronic mirrors, there are mirrors that display a 3D image (stereoscopic image) (see Patent Literatures 1 and 2). 3D images create a natural sense of depth. Therefore, a driver can intuitively and easily know a position and a speed of an object (visible object) which is displayed on the display screen. In addition, 3D images are displayed on a farther (deeper) side relative to the display screen in a sight of a driver. Accordingly, an observing point of the driver is farther in the case of 3D images as compared to 2D images. Therefore, the driver feels it easy to shift his/her eyes away from a point ahead of a vehicle to the display screen and recognize the visible object which is displayed on the display screen.

In a general display device for displaying 3D images, a right eye image (image for the right eye) and a left eye image (image for the left eye) are created from one image. These right and left eye images are displayed and viewed via a parallax barrier, so that an image is stereoscopically viewed. Accordingly, in a case where a position of a right eye of a user and/or a position of a left eye of the user is/are outside a positional predetermined range, the left and right eye images cannot be viewed as a 3D image. What is even worse, in such a case, the right and left eye images appear as overlapped images. This may hinder user's driving.

In view of the above, Patent Literature 3 discloses a display device which switches 3D image display to 2D image display so that user's driving will not be hindered, in a case where during the 3D image display, a position of a right eye of the user and/or a position of a left eye of the user moves outside a positional predetermined range.

### CITATION LIST

### Patent Literature

[Patent Literature 1] Japanese Patent Application Publication, Tokukai, No. 2013-026770 (Publication Date: Feb. 4, 2013)

[Patent Literature 2] Japanese Patent Application Publication, Tokukai, No. 2003-339060 (Publication Date: Nov. 28, 2003)

[Patent Literature 3] Japanese Patent Application Publication, Tokukai, No. 2015-215505 (Publication Date: Dec. 3, 2015)

### SUMMARY OF INVENTION

### Technical Problem

However, in the case of a parallax barrier display device, if a distance between that display device and right and left eyes of a user is outside a distance predetermined range, the user cannot appropriately view a displayed image even in a case where the position of the right eye of the user and/or the position of the left eye of the user is/are within the positional predetermined range. For example, in a case where the distance between the display device and the right and left eyes of the user becomes too short, left eye pixels (pixels for the left eye) are viewed by the right eye while right eye pixels (pixels for the right eye) are viewed by the left eye due to a positional relation between these pixels and the parallax barrier, as illustrated in FIG. 8. As a result, the user views a double image. On this account, in a case where a conventional parallax barrier display device is used as an electronic mirror of a vehicle, driving may be hindered. Note that a distance between a display device and the right eye of a user is substantially equal to a distance between the display device and the left eye of the user.

An object of an aspect of the present invention is to provide a display device which does not hinder driving even in a case where the display device, which is a parallax barrier display device, is used as an electronic mirror of a vehicle.

### Solution to Problem

In order to solve the above problem, a display device in accordance with an aspect of the present invention is configured to include: a display section capable of switching between 2D display and 3D display, the 3D display being carried out by a parallax barrier method; a distance measuring section for measuring a distance from an eye of a user to a display screen of the display device; and a display switching section for switching display from the 3D display to the 2D display in a case where the distance measured by the distance measuring section is outside a predetermined range.

### Advantageous Effects of Invention

An aspect of the present invention makes it possible to provide a display device which does not hinder driving.

### BRIEF DESCRIPTION OF DRAWINGS

FIG. 1 is a block diagram schematically illustrating a configuration of an electronic mirror in accordance with Embodiment 1 of the present invention.

FIG. 2 is a view illustrating a state of a driver's seat area of a vehicle which is equipped with the electronic mirror illustrated in FIG. 1.

FIG. 3 is a top view of the vehicle illustrated in FIG. 2.

FIG. 4 is a view illustrating an example of a parallax barrier image display device which is provided in an electronic mirror illustrated in FIG. 1.

FIG. 5 is a view illustrating a distance between the image display device illustrated in FIG. 4 and both eyes of a driver.

FIG. 6 is a view for explaining some of steps in a process for displaying a 3D image by a parallax barrier method in the image display device illustrated in FIG. 4.

FIG. 7 is a view showing a case where a distance between a position of eyes and a position of a display device is appropriate in recognition of a 3D image by a parallax barrier method in the image display device illustrated in FIG. 4.

FIG. 8 is a view showing a case where a distance between a position of eyes and a position of a display device is too short in recognition of a 3D image by a parallax barrier method in the image display device illustrated in FIG. 4.

FIG. 9 is a flowchart showing a flow of a process for switching 3D display to 2D display in the electronic mirror illustrated in FIG. 1.

FIG. 10 is a flowchart showing a flow of a process for switching 3D display to 2D display in an electronic mirror in accordance with Embodiment 2 of the present invention.

FIG. 11 is a block diagram schematically illustrating a configuration of an electronic mirror in accordance with Embodiment 3 of the present invention.

### DESCRIPTION OF EMBODIMENTS

### Embodiment 1

The following description will discuss details of an embodiment of the present invention.

(Configuration of Automobile Equipped with Electronic Mirror)

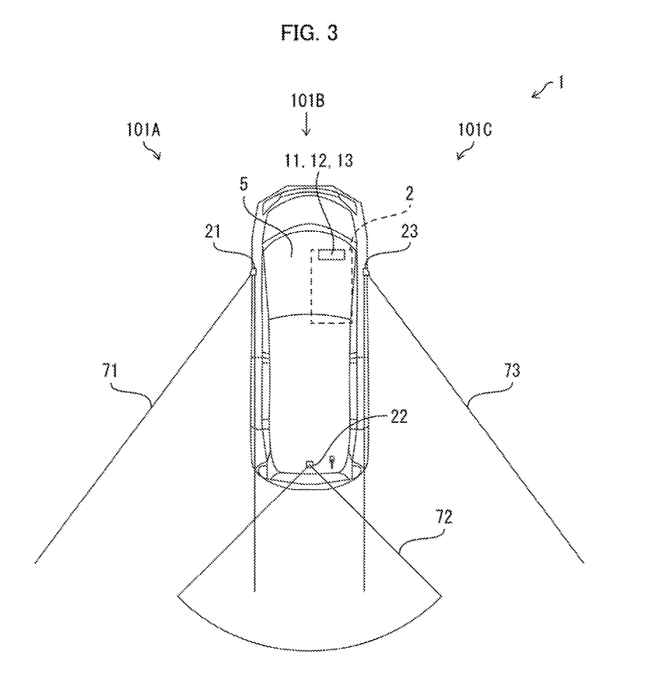

With reference to FIGS. 2 and 3, the following will discuss a display device in accordance with Embodiment 1 of the present invention. FIG. 3 is a top view of a vehicle equipped with the display device in accordance with Embodiment 1 of the present invention. FIG. 2 is a view illustrating a state of a driver's seat area of the vehicle which is equipped with the display device in accordance with Embodiment 1 of the present invention.

Note that Embodiment 1 describes an example in which the display device in accordance with an embodiment of the present invention is mounted on a four-wheeled vehicle as an example of the vehicle. However, the vehicle equipped with the display device in accordance with an embodiment of the present invention is not limited to four-wheeled vehicles. It is possible to mount the display device in accordance with an embodiment of the present invention on various vehicles such as two-wheeled vehicles including bikes, and three-wheeled vehicles. Further, the four-wheeled vehicles are not limited to a particular kind. The display device in accordance with an embodiment of the present invention can be mounted on compact cars, middle-sized cars, large cars, trucks, buses, and the like.

Further, Embodiment 1 will describe an example in which the display device in accordance with an embodiment of the present invention is used as an electronic mirror. However, the display device in accordance with an embodiment of the present invention can be also used as various in-vehicle displays such as a display for a car navigation system.

As illustrated in FIG. 5, an automobile (vehicle) 1 includes an electronic mirror 101A for a left side of the automobile 1, an electronic mirror 101B for a rear side opposite to the front of the automobile 1, and an electric mirror 101C for a right side of the automobile 1.

The electronic mirror 101A includes a display section (display device) 11 and an image pickup section 21. The electronic mirror 101B includes a display section (display device) 12 and an image pickup section 22. The electronic mirror 101C includes a display section (display device) 13 and an image pickup section 23.

The electronic mirror 101A has a function which substitutes for a function of a left door mirror. The electronic mirror 101B has a function which substitutes for a function of a room mirror. The electronic mirror 101C has a function which substitutes for a function of a right door mirror. Therefore, none of the left door mirror, the room mirror, and the right door mirror needs to be provided in the automobile 1.

The image pickup sections 21, 22, and 23 are each an in-vehicle camera capable of capturing a moving image. The image pickup sections 21, 22, and 23 are each made of, for example, a CCD camera, a CMOS camera, or the like.

The image pickup section 21 is provided at a position where the left door mirror is typically provided, in the automobile 1. The image pickup section 21 captures a moving image in a left rear range 71 of the automobile 1, and outputs, to the display section 11, an image signal of the moving image thus captured. Note that in the automobile 1, the image pickup section 21 need only be provided at a position at which the image pickup section 21 can capture a moving image in the left rear range 71.

The image pickup section 22 is provided at a rear portion of a ceiling. The image pickup section 22 captures a moving image in a rear range 72 of the automobile 1 which rear range is opposite to the front of the automobile 1, and outputs, to the display section 12, an image signal of the moving image thus captured. Note that in the automobile 1, the image pickup section 22 need only be provided at a position at which the image pickup section 22 can capture a moving image in the rear range 72 that is opposite to the front of the automobile 1. In the automobile 1, for example, the image pickup section 22 may he provided on a rear surface where a rear bumper, a number plate, or the like is provided.

The image pickup section 23 is provided at a position where the right door mirror is typically provided, in the automobile 1. The image pickup section 23 captures a moving image in a right rear range 73 of the automobile 1, and outputs, to the display section 13, an image signal of the moving image thus captured. Note that in the automobile 1, the image pickup section 23 need only be provided at a position at which the image pickup section 23 can capture a moving image in the right rear range 73. Note that the image pickup sections 21, 22, and 23 each can widen or narrow the range 71, 72, or 73 for image capturing by changing a field angle in capturing an image.

The display sections 11, 12, and 13 are provided in a room of the automobile 1. In Embodiment 1, the display sections 11, 12, and 13 are provided in a driver's seat area 2. The display section 11 displays an image of the left rear range 71 of the automobile 1, which image is captured by the image pickup section 21. The display section 11 displays the image not as a 2D (planar) image but as a 3D (depth) image. The display section 12 displays an image of the rear range 72 of the automobile 1 which rear range 72 is opposite to the front of the automobile 1. That image of the rear range 72 is an image captured by the image pickup section 22. The display section 12 displays the image as a 3D (depth) image. The display section 13 displays an image of the right rear range 73 of the automobile 1, which image is captured by the image pickup section 23. The display section 13 displays the image a 3D (depth) image.

Accordingly, different from a case where the image obtained by capturing an image around the automobile 1 is displayed as a planar image, the above allows a driver (user) to view an image which gives the driver a sense of depth. Then, the driver can easily know a distance between visible objects in the images displayed on the display sections 11, 12, and 13, and also can easily have a sense of distance between the visible objects and the automobile 1 that the driver himself/herself is driving. In this way, the display section 11, 12, and 13 each can display an image that creates a less feeling of strangeness.

Note that the 3D (depth) image is an image which gives a sense of depth, unlike a 2D (planar) image. In particular, the 3D (depth) images displayed on the display sections 11, 12, and 13 in accordance with Embodiment 1 each not only give a sense of depth but also allow a driver to feel as if he/she were looking at a mirror.

In the driver's seat area 2 of the automobile 1, the display sections 11, 12, and 13 are provided at a position ahead of a driver in a case where the driver sits on a driver's seat. This decreases an amount of shift in sight line when the driver shifts his/her eyes from a position of a visible object such as a road which the driver views through a front glass 5 to the display sections 11, 12, and 13. This makes it possible to shorten a time for which the driver inattentively drives, in a case where the driver is to view the images displayed on the display sections 11, 12, and 13.

Further, the display section 12 is provided at a position which is in front of a driver when the driver sits on the driver's seat. Meanwhile, the driver sitting on the driver's seat sees the display section 11 provided on the left of the display section 12. Furthermore, the driver sitting on the driver's seat sees the display section 13 provided on the right of the display section 12.

On this account, the driver can intuitively know the following (1) to (3): (1) the display section 11 displays a moving image in the left rear range 71 of the automobile 1; (2) the display section 12 displays a moving image in the rear range 72 of the automobile 1, which rear range is opposite to the front of the automobile 1; and (3) the display section 13 displays a moving image in the right rear range 73 of the automobile 1.

The display sections 11, 12, and 13 are embedded in a dashboard. The automobile 1 in accordance with Embodiment 1 also displays, on a display device 3, an instrument panel including various gauges such as a speedometer, a gauge indicating an amount of remaining fuel, and the like. The display device 3 is embedded in the dashboard. Then, the front glass 5, the display sections 11, 12, and 13, and the display device 3 are provided such that the driver sees the front glass 5, the display sections 11, 12, and 13, and the display device 3 in this order from an upper side to a lower side.

Note that the positions where the display sections 11, 12, and 13 are provided are not limited to the above-described positions. The display sections 11, 12 and 13 may be provided at any positions as long as the driver can see the display sections 11, 12, and 13 at the positions. For example, the display sections 11, 12, and 13 may be included in the display device 3. Alternatively, the display sections 11, 12, and 13 may be provided at positions where a room mirror is typically provided, or at a position on an inner side of a door.

(Details of Electronic Mirror)

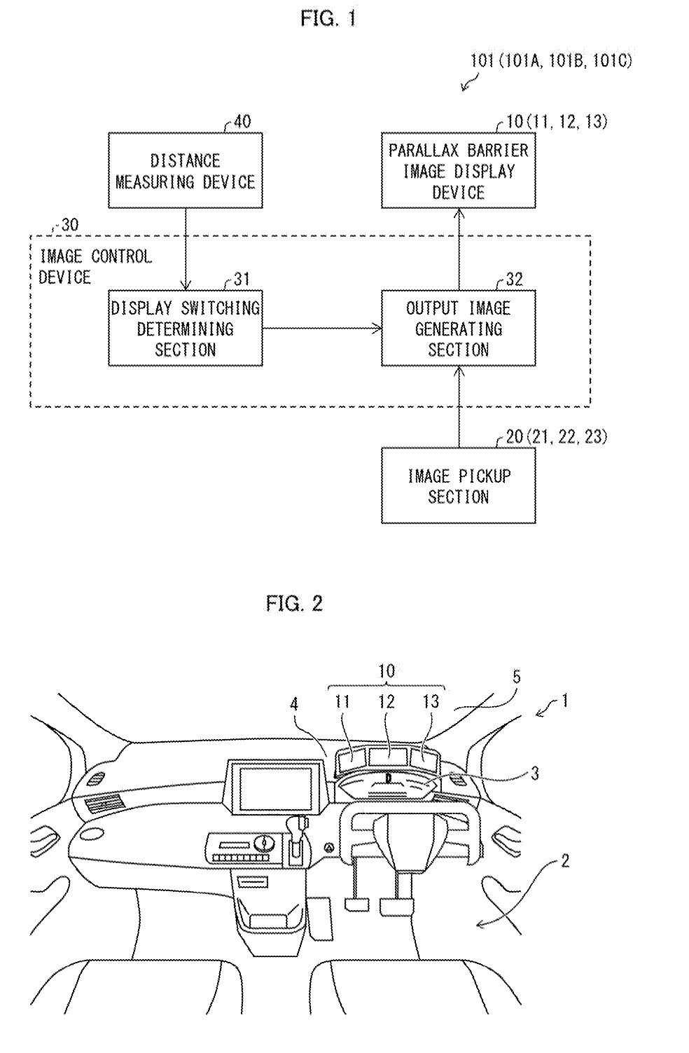

With reference to FIG. 1, the following will discuss a configuration of the electronic mirror 101 in accordance with Embodiment 1. Since the electronic mirrors 101A, 101B, and 101C illustrated in FIG. 3 have the same configuration, the electronic mirrors 101A, 101B, and 101C are collectively called an “electronic mirror 101” in the following description with reference to FIG. 1. Accordingly, in the following description with reference to FIG. 1, the display sections 11 to 13 are collectively called a parallax barrier image display device (hereinafter, referred to as “image display device”) 10, and the image pickup sections 21 to 23 are collectively called an image pickup section 20. FIG. 1 is a block diagram illustrating a configuration of an electronic mirror 101.

An electronic mirror 101 includes the parallax barrier image display device (display section) 10, the image pickup section 20, an image control device 30, and a distance measuring device 40, as illustrated in FIG. 1. The image control device 30 and the parallax barrier image display device 10 constitute a display device.

The image control device 30 obtains a captured image from the image pickup section 20. Then, the image control device 30 generates, from the captured image thus obtained, an output image to be outputted to the image display device 10. The output image contains an image for a right eye of a driver (hereinafter, referred to as right eye pixel data) and an image for a left eye of the driver (hereinafter, referred to as left eye pixel data). As illustrated in FIG. 1, the image control device 30 includes a display switching determining section 31, and an output image generating section 32. Each section of the image control device 30 will be described later.

The image display device 10 displays, on a display screen, the output image which has been generated by the image control device 30. The image display device 10 may be, for example, a liquid crystal display device. Then, the output image displayed on the display screen by the image display device 10 is based on the captured image from the image pickup section 20. Meanwhile, the display device 3 illustrated in FIG. 2 displays, on its display screen, an output image based on a digital image including information on a vehicle speed of the automobile 1, the number of engine rotations, the gear in use, and the like.

The distance measuring device 40 measures a direct distance between the display screen of the image display device 10 and both eyes of a driver who is driving the vehicle. The distance measuring device 40 sends a measurement result to the image control device 30. Details of distance measurement by the distance measuring device 40 will be described later.

(Configuration of Image Control Device 30)

As illustrated in FIG. 1, the image control device 30 includes the display switching determining section 31 and the output image generating section 32. In the following description, display of a 3D image will be referred to as 3D display whereas display of a 2D image will be referred to as 2D display.

To the display switching determining section 31, the distance measuring device 40 sends a measured value of the direct distance between the display screen of the image display device 10 and both eyes of a driver. The display switching determining section 31 determines whether or not the direct distance is within a predetermined range, on the basis of the measured value of the direct distance. The display switching determining section 31 sends a result of that determination to the output image generating section 32. The predetermined range here means a distance range which allows the driver to appropriately view an image of the 3D display on the image display device 10. In Embodiment 1, the predetermined range is set to a range of 50 cm to 120 cm. Note that the predetermined range is not limited to the range of 50 cm to 120 cm. The predetermined range varies depending on various conditions such as a display screen size of the image display device 10.

The output image generating section 32 generates an output image by alternately arranging the left eye pixel data and the right eye pixel data from one captured image. The output image generating section 32 also generates an output image switched to an image corresponding to 3D display or 2D display in accordance with the determination result of the display switching determining section 31. More specifically, in a case where the determination result sent from the display switching determining section 31 during the 3D display indicates that the direct distance between the display screen of the image display device 10 and both eyes of a driver are outside the predetermined range, for example, in a case where the distance between the display screen of the image control device 10 and the eyes of the driver is close to each other, the output image generating section 32 generates an output image switched to an image corresponding to the 2D display and outputs the output image to the image control device 30. Note that a method of generating an image in the 3D display is a general method, and therefore an explanation of details thereof will be omitted here.

(Arrangement of Image Display Device 10)

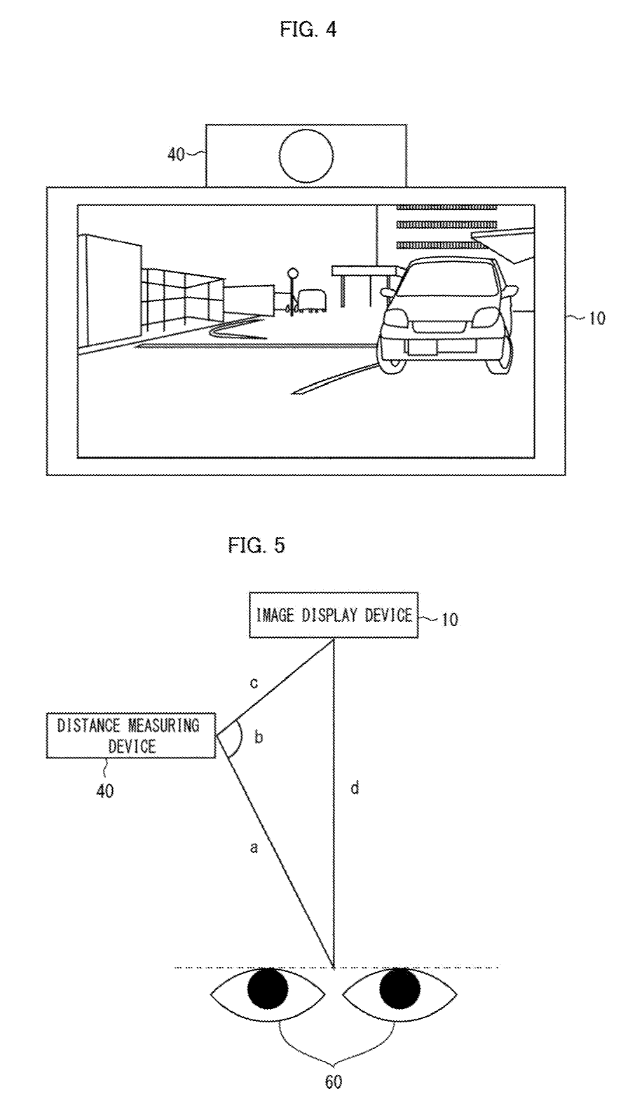

FIG. 4 shows an example of how the image display device 10 and the distance measuring device 40 are arranged. In this example, the image display device 10 and the distance measuring device 40 are integrated into one unit. In other words, a position of the distance measuring device 40 for measuring a distance to both eyes of a driver is substantially the same as a position of the image display device 10 which the driver (user) views. In this case, when the image display device 10 vibrates, the distance measuring device 40 similarly vibrates. Accordingly, an amplitude of vibration of the image display device 10 is equal to that of the distance measuring device 40. Therefore, the distance between the display screen of the image control device 10 and eyes of a driver can be appropriately measured by use of the distance measuring device 40.

Further, when the image display device 10 and the distance measuring device 40 are integrated into one unit, the distance between the image display device 10 and eyes of a driver is equal to a distance between the distance measuring device 40 and the eyes of the driver. Accordingly, the distance measured by the distance measuring device 40 can directly be the distance between the image display device 10 and the eyes of the driver. In this case, the distance measuring device 40 can be a device such as a monocular camera or a stereo camera. In a case where the monocular camera is used, a distance between the monocular camera and both eyes of a driver is defined as a reference distance and an area of the both eyes of the driver in that case is measured in advance. Then, a distance to an object to be measured can be calculated on the basis of an area of the both eyes in a captured image. Note that the distance measuring device 40 may be a device which utilizes infrared to measure a distance to an object to be measured.

Note that an embodiment of the present invention is not limited to a structure in which the image display device 10 and the distance measuring device 40 are integrated into one unit. The image display device 10 and the distance measuring device 40 may be provided at separate positions, respectively. In such a case, the distance between the image display device 10 and both eyes of a driver may be measured by using the law of cosines as illustrated in FIG. 5.

That is, when the distance between the image display device 10 and both eyes 60 of a driver is to be measured by the distance measuring device 40, a three-dimensional (x, y, z) distance between the distance measuring device 40 and the image display device 10 is fixed in advance. Then, the distance between the image display device 10 and the both eyes 60 of the driver is calculated by measuring the distance between the distance measuring device 40 and the eyes 60 of the driver.

Specifically, a positional relation (distance a) between the distance measuring device 40 and the both eyes 60 of the driver is measured in a three-dimensional coordinate system by use of the distance measuring device 40. In this case, positions (distance c) of the distance measuring device 40 and the image display device 10 are fixed in advance. Accordingly, a positional relation between the image display device 10 and the distance measuring device 40 in the three-dimensional coordinate system is known in advance in the distance measuring device 40. When coordinates of the both eyes 60 and coordinates of the distance measuring device 40 are found, a side a, a side b, and an angle b as shown in FIG. 5 are known, so that a distance d is calculated by the law of cosines. The distance d thus calculated is sent to the display switching determining section 31.

In a case where the distance d calculated by the distance measuring device 40 is within a predetermined range (a range in which an image in 3D display is appropriately viewed) while the 3D display is being carried out, the display switching determining section 31 instructs the output image generating section 32 to keep the 3D display. In contrast, in a case where the distance d is outside the above predetermined range while the 3D display is being carried out, the display switching determining section 31 instructs the output image generating section 32 to switch the 3D display to 2D display.

Note that in a case where the distance d calculated by the distance measuring device 40 is within the predetermined range (the range in which an image in 3D display is appropriately viewed) while 2D display is being carried out, the display switching determining section 31 may instruct the output image generating section 32 to switch the 2D display to 3D display. In contrast, in a case where the distance d is outside the above predetermined range while the 2D display is being carried out, the display switching determining section 31 may instruct the output image generating section 32 to keep the 2D display.

(3D Display by Parallax Barrier Method)

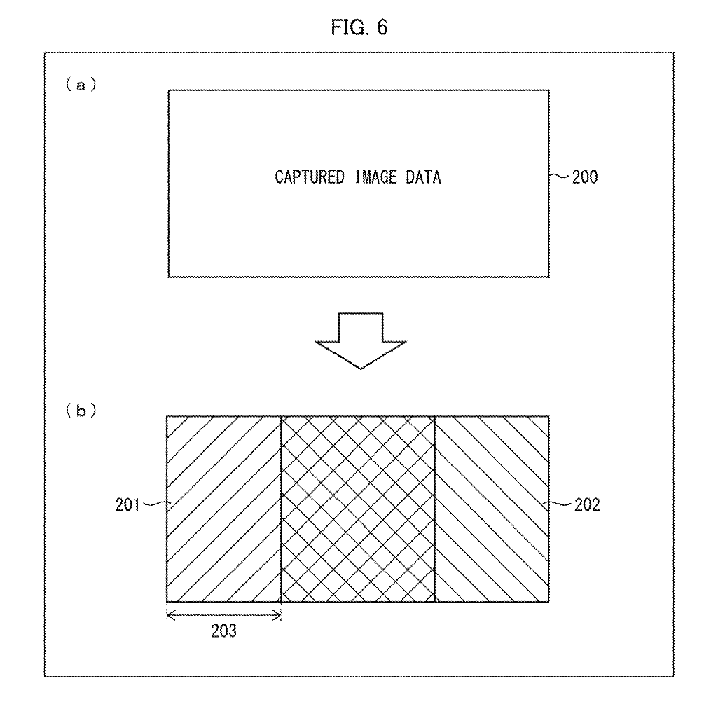

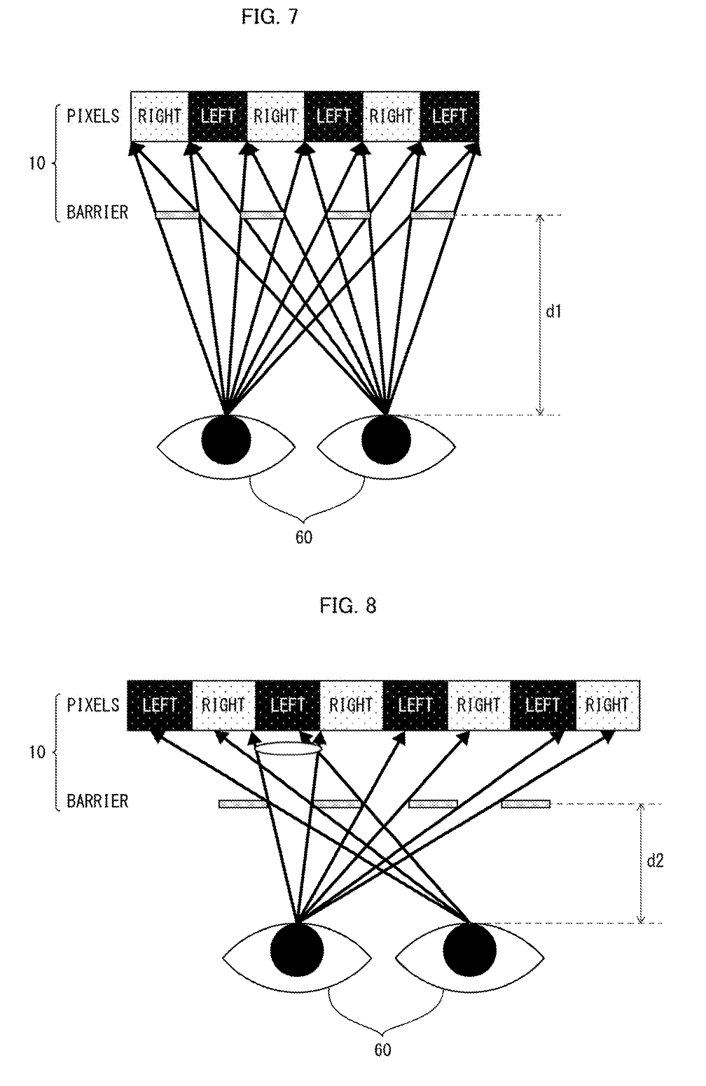

The following will discuss 3D display by a parallax barrier method, with reference to FIGS. 6 to 8.

The output image generating section 32 generates left eye pixel data and right eye pixel data from image data 200 illustrated in (a) of FIG. 6 which has been captured by the image pickup section 20. In this case, as illustrated in (b) of FIG. 6, a viewing angle range 201 of the left eye pixel data and a viewing angle range 202 of the right eye pixel data are shifted by a predetermined number of pixels. As a shift amount 203 in viewing angle range increases, a visible object contained in the image data 200 is viewed at a larger depth. In other words, as the shift amount 203 increases, a resultant 3D image has a larger depth.

As illustrated in FIG. 7, the left eye pixel data and the right eye pixel data are alternately displayed. In this configuration, when a 3D image is viewed, through a barrier, at a position where a distance d1 from both eyes 60 of a driver to the barrier (image display device 10) is appropriate, the driver can appropriately view the 3D image if the position is a position where only the left eye pixel data is viewable to the left eye of the driver and only the right eye pixel data is viewable to the right eye of the driver.

However, as illustrated in FIG. 8, when the distance d1 decreases to a distance d2 from the both eyes 60 to the barrier (image display device 10) while a 3D image is being displayed, the right eye pixel data becomes also visible to the left eye and the left eye pixel data becomes also visible to the right eye. As a result, overlapped images are viewed. In this case, the image control device 30 switches 3D display to 2D display as described below.

(Switching from 3D Display to 2D Display)

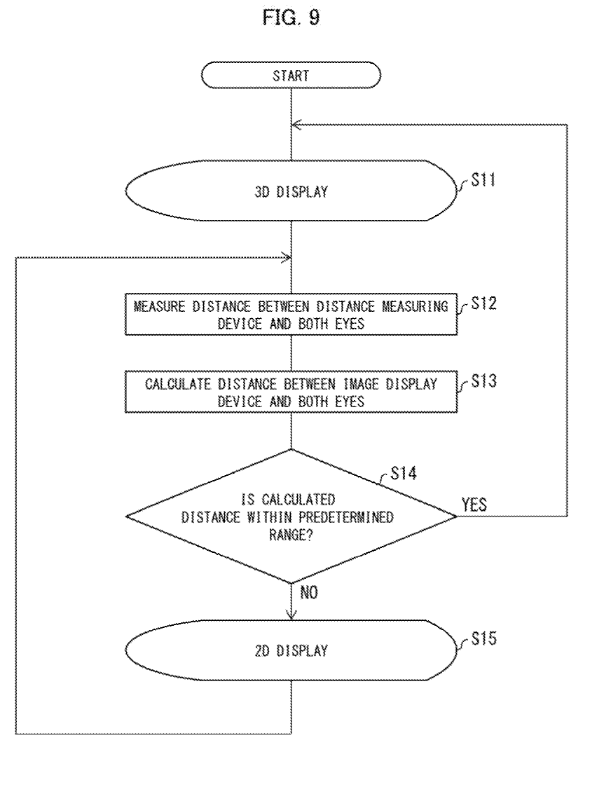

FIG. 9 is a flowchart showing a flow of a process for switching 3D display to 2D display. Note that the following describes an example in which the image display device 10 and the distance measuring device 40 are provided at separate positions, respectively, as illustrated in FIG. 5.

First, during 3D display (Step S11), the distance measuring device 40 measures a distance between the distance measuring device 40 and both eyes 60 (Step S12). The distance measuring device 40 here captures an image of the both eyes 60, and calculates the distance from the distance measuring device 40 to the both eyes 60 on the basis of an area of the both eyes 60.

Next, the distance measuring device 40 calculates a distance from the image display device 10 to the both eyes 60 on the basis of the distance between the distance measuring device 40 and the both eyes 60 (step S13: distance measuring step, step of measuring a distance). Calculation of the distance here is performed by using the law of cosines as illustrated in FIG. 5.

Subsequently, the display switching determining section 31 determines whether or not the distance calculated in step S13 is within a predetermined range (step S14: display switching step, the step of switching display). Here, in a case where the distance thus calculated is within the predetermined range (YES in step S14), the process moves on to step S11 and the 3D display is continued. In contrast, in a case where the distance thus calculated is outside the predetermined range (NO in step S14), the 3D display is switched to 2D display and the process moves on to step S12. Then, the distance measuring device 40 measures again the distance between the distance measuring device 40 and the both eyes 60.

As described above, in a case where the distance between the image display device 10 and the both eyes 60 falls outside the predetermined range during 3D display, for example, in a case where the both eyes 60 come too close to the image display device 10, the 3D display is switched to 2D display. In other words, in a case where the distance between the parallax barrier (image display device 10) and the both eyes 60 of a driver falls outside the predetermined range during 3D display, the 3D display is changed to 2D display. This allows the driver to correctly view a visible object(s) contained in an image and to safely drive a vehicle.

### Embodiment 2

The following description will discuss details of another embodiment of the present invention. Note that, for convenience of explanation, identical reference numerals are given to members which have respective functions identical with those described in the above Embodiment 1, and descriptions of the respective members will not be repeated.

In Embodiment 1, in a case where during 2D display, the distance between the image display device 10 and the both eyes 60 of a driver changes from outside a predetermined range to be within the predetermined range, the 2D display is immediately switched to 3D display. In contrast, in Embodiment 2, the following will discuss an example in which 2D display is switched to 3D display after a predetermined length of time has elapsed from a time point at which a distance between an image display device 10 and both eyes 60 of a driver falls within a predetermined range.

(Switching from 2D Display to 3D Display)

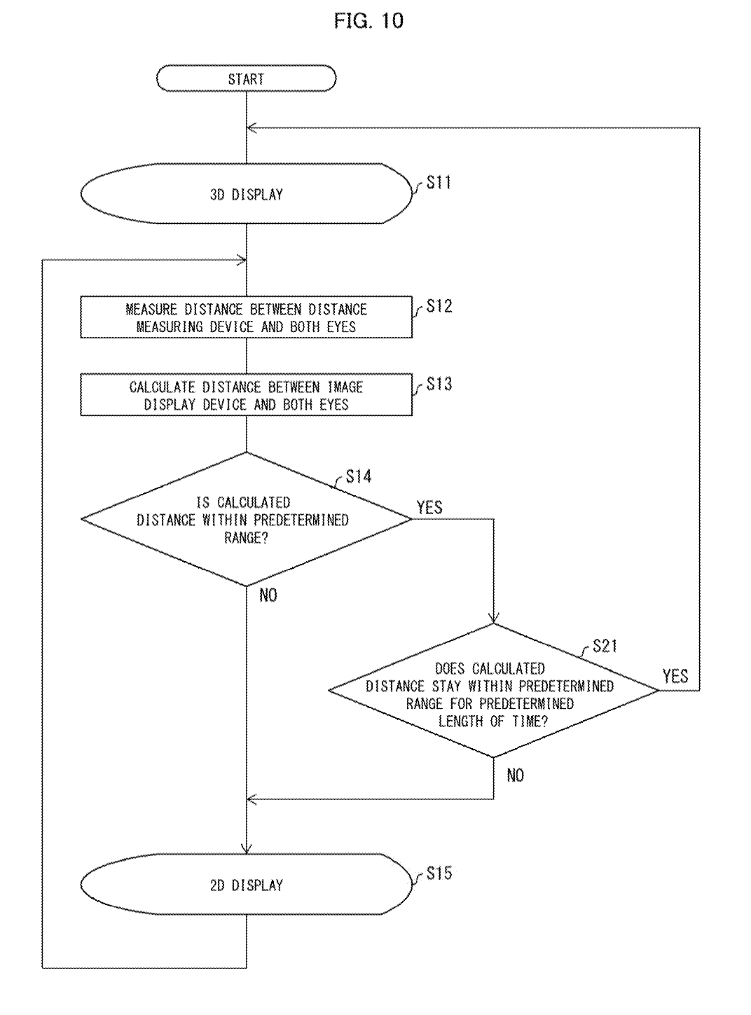

FIG. 10 is a flowchart illustrating a flow of a process for switching 2D display to 3D display in an electronic mirror in accordance with Embodiment 2 of the present invention. Note that in Embodiment 2, the following describes an example in which the image display device 10 and a distance measuring device 40 are provided at separate positions, respectively, as illustrated in FIG. 5 as in Embodiment 1.

Though the flowchart of FIG. 10 is mostly the same as the flowchart of FIG. 9 which is referred to in the description in Embodiment 1, the flowchart of FIG. 10 is different form the flowchart of FIG. 9 in that step S21 is inserted between steps S14 and S15.

After a display switching determining section 31 determines during 2D display that a distance calculated is within the predetermined range (YES in step S14), the display switching determining section 31 measures, in step S21, a time for which that determination result continues. Then, the display switching determining section 31 determines whether or not the time thus measured has exceeded a predetermined length of time. In a case where the time thus measured is not less than the predetermined length of time (YES), the 2D display is switched to 3D display. In contrast, in a case where the time thus measured is less than the predetermined length of time (NO), the 2D display is kept. The predetermined length of time here is, but is not limited to, for example, 2 seconds.

For example, when a switching process for switching from 2D display to 3D display is to be carried out as illustrated in FIG. 9 of the above Embodiment 1, there may be a case where the distance to both eyes of a driver is barely within or outside the predetermined range. In such a case, a result of determining whether the distance calculated is within or outside the predetermined range frequently switches due to vibration caused by driving. Then, in such a case, the 2D display is soon switched to 3D display. Soon after this switch from the 2D display to the 3D display, the 3D display will be switched to 2D display when the driver returns to an original position where the distance to the both eyes of the driver is within the predetermined range. If display is frequently switched between 2D display and 3D display in this way, the driver may suffer from eye strain.

In view of the above, as illustrated in FIG. 10, unless the predetermined length of time elapses after a condition for switching to 3D display is satisfied during 2D display, the 2D display is continued. Then, after the predetermined length of time has elapsed, the 2D display is switched to 3D display. In this configuration, even in a case where the distance to the both eyes of the driver is barely within or outside the predetermined range and accordingly, a result of determining whether the distance calculated is within or outside the predetermined range frequently switches, a 2D image is not switched a 3D image. This allows the driver to reduce eye strain caused by display switching when the driver views the image display device 10.

Note that Embodiments 1 and 2 each have discussed an example in which switching from 2D display to 3D display is promptly carried out, but the following embodiment will discuss an example in which switching from 2D display to 3D display is gradually carried out.

### Embodiment 3

The following description will discuss details of still another embodiment of the present invention. Note that, for convenience of explanation, identical reference numerals are given to members which have respective functions identical with those described in the above Embodiment 1 or 2, and descriptions of the respective members will not be repeated.

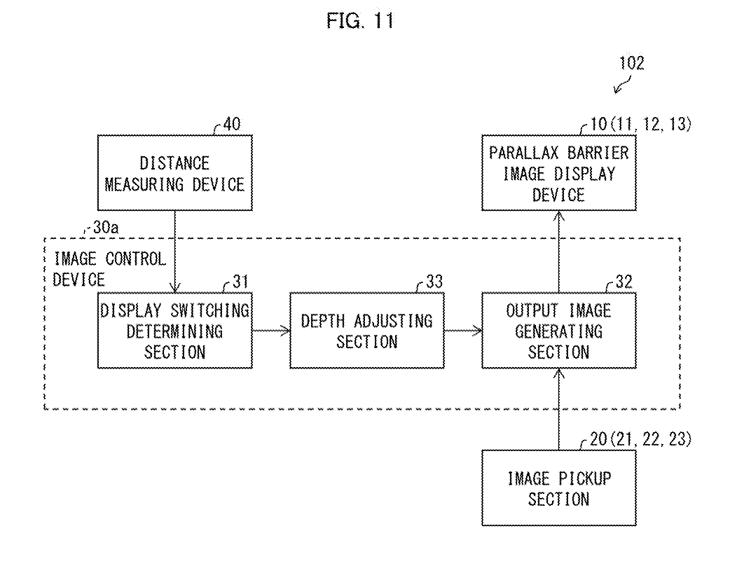

FIG. 11 is a block diagram schematically illustrating a configuration of an electronic mirror 102 in accordance with Embodiment 3. As illustrated in FIG. 11, the electronic mirror 102 in accordance with Embodiment 3 is mostly the same in configuration as the electronic mirror 101 in accordance with Embodiment 1, but is different in an image control device 30a from the electronic mirror 101. In other words, the image control device 30a is configured to additionally include a depth adjusting section 33 in the image control device 30 in accordance with the above Embodiment 1.

The depth adjusting section 33 adjusts a depth of an output image generated by the output image generating section 32. The depth of the output image is a parameter indicative of a depth of a position of a visible object in the output image (i.e., a parameter indicative of a distance from a display screen to the visible object) in a view of a driver. The depth may be a positive or negative value or zero. In Embodiment 3, the depth adjusting section 33 adjusts a pixel shift amount Δpix (amount of pixel shift) between right eye pixel data and left eye pixel data, depending on whether display is 2D display or 3D display.

When the depth adjusting section 33 receives, from the display switching determining section 31, a determination result instructing to switch from 2D display to 3D display, the depth adjusting section 33 sends, to the output image generating section 32, a signal which is adjusted so that the pixel shift amount Δpix in carrying out 3D display will be achieved in a predetermined time period.

Next, the output image generating section 32 generates an image in accordance with the signal from the depth adjusting section 33 so that the pixel shift amount Δpix in carrying out the 3D display will be achieved in the predetermined time period. Then, the output image generating section 32 sends the signal thus generated to the image display device 10. In this case, when the predetermined time period is, for example, a period of two frames, pixels of the left eye pixel data and pixels of the right eye pixel data are shifted from each other such that the pixel shift amount Δpix is achieved in a period of two frames. Then, 3D display is ultimately carried out.

As described above, when 2D display is switched to 3D display, a depth of a visible object contained in an image is gradually increased from that in the case of the 2D display. This removes a feel of strangeness in a driver when display is switched from the 2D display to the 3D display.

[Software Implementation Example]

Control blocks of the electronic mirror 101 or 102 (particularly, the image control device 30 and the image control device 30a) may be realized by a logic circuit (hardware) provided in an integrated circuit (IC chip) or the like or may be realized by software.

In the latter case, the electronic mirror 101 or 102 includes a computer that executes instructions of a program that is software realizing the foregoing functions. This computer includes, for example, at least one processor (control device) and at least one computer readable storage medium in which the program is stored. The object of the present invention can be achieved by the processor reading and executing the program stored in the storage medium in the computer. Note that the process can be, for example, a Central Processing Unit (CPU). The storage medium may be “a non-transitory tangible medium” such as a Read Only Memory (ROM), a tape, a disk, a card, a semiconductor memory, and a programmable logic circuit. Further, the storage medium may further include a Random Access Memory (RAM) that develops the program in executable form. Further, the program may be supplied to or made available to the computer via any transmission medium (such as a communication network and a broadcast wave) which enables transmission of the program. Note that an aspect of the present invention can also be implemented by the program in the form of a computer data signal embedded in a carrier wave which is embodied by electronic transmission.

[Recap]

A display device in accordance with Aspect 1 of the present invention is a display device capable of switching between 2D display and 3D display, the 3D display being carried out by a parallax barrier method, the display device including: a distance measuring section (distance measuring device 40) for measuring a distance from eyes 60 of a user (driver) to a display screen of a display section (image display device 10); and a display switching section (display switching determining section 31) for switching display from the 3D display to the 2D display in a case where the distance measured by the distance measuring section (distance measuring device 40) is outside a predetermined range.

The 3D display is not appropriately displayed unless the distance from eyes of a user to the display screen of the display device is within the predetermined range. In the above configuration, display is switched to the 2D display in a case where the distance measured by the distance measuring section falls outside the predetermined range during the 3D display. Accordingly, it is prevented that an inappropriate display image is viewed. Such a configuration makes it possible to appropriately recognize a visible object in an image all the time in both of the 3D display and the 2D display. Therefore, when the display device is mounted to an in-vehicle electronic mirror, hindrance to user's driving is reliably avoided.

A display device in accordance with Aspect 2 of the present invention may be configured to further include, in the above Aspect 1, an image generating section (output image generating section 32) for generating right eye pixel data and left eye pixel data from an image, the predetermined range having a minimum value which indicates a distance at which a right eye of the user starts recognizing the left eye pixel data or at which a left eye of the user starts recognizing the right eye pixel data.

In the above configuration, the minimum value of the predetermined range indicates a distance at which the right eye of the user starts recognizing the left eye pixel data or at which the left eye of the user starts recognizing the right eye pixel data. Accordingly, a trouble such as viewing a double image occurs in a case where the distance from the eyes of the user to the display screen of the display device becomes equal to or less than the minimum value of that predetermined range. In view of the above, in a case where the distance from the eyes of the user to the display screen of the display device becomes equal to or less than the minimum value of that predetermined range during the 3D display, the 3D display is switched to the 2D display. This prevents the occurrence of a trouble such as viewing a double image. The above configuration allows the eyes of the user to appropriately recognize a visible object in an image all the time even in a case where the eyes of the user approaches too close to the display screen of the display device during the 3D display. Therefore, when the display device is mounted to an in-vehicle electronic mirror, hindrance to user's driving is reliably avoided.

A display device in accordance with Aspect 3 of the present invention may be configured such that, in the above Aspect 2, the image generating section (output image generating section 32) generates the image such that (i) the image has a small depth in a case where during the 3D display, the distance measured by the distance measuring section (distance measuring device 40) is within the predetermined range and larger than a preset value and (ii) the image has a large depth in a case where during the 3D display, the distance measured by the distance measuring section (distance measuring device 40) is within the predetermined range and smaller than the preset value.

If the distance from the eyes of the user to the display screen of the display device is within the predetermined range during 3D display, the user can appropriately recognize an image of the 3D display. However, even in a case where the distance is within the predetermined range, how the image of the 3D display appears may be different if the distance is close to an upper limit or lower limit of the predetermined range. For example, in a case where the distance is close to the upper limit of the predetermined range, the eyes of the user is farther from the display screen. As a result, the image of the 3D display appears to have a large depth. Therefore, it is preferable to make the depth of the image of the 3D display small. In contrast, in a case where the distance is close to the lower limit of the predetermined range, the eyes of the user are closer to the display screen. As a result, the image of the 3D display appears to have a small depth. Therefore, it is preferable to make the depth of the image of the 3D display large. Accordingly, the display device is configured as above such that: the image generating section generates the image such that (i) the image has a small depth in a case where during the 3D display, the distance measured by the distance measuring section is within the predetermined range and larger than a preset value and (ii) the image has a large depth in a case where during the 3D display, the distance measured by the distance measuring section is within the predetermined range and smaller than the preset value. This allows the user to appropriately recognize a visible object all the time during 3D display. Therefore, when the display device is mounted to an in-vehicle electronic mirror, hindrance to user's driving is reliably avoided.

A display device in accordance with Aspect 4 of the present invention may be configured such that in any one of the above Aspects 1 to 3, the display switching section (display switching determining section 31) does not switch the 2D display to the 3D display in a case where during the 2D display, the distance measured by the distance measuring section (distance measuring device 40) is within the predetermined range for a time of less than a predetermined length of time.

In a case where the distance from the eyes of the user to the display screen of the display device falls within the predetermined value during the 2D display and then, the distance soon returns to be outside the predetermined range, display is switched first to the 3D display and then soon to the 2D display. In a case where switching of display carried out more than necessary, it becomes difficult for a user to view a visible object in an image displayed. In light of the above, the display device is configured as described above such that switching to the 3D display is not carried out in a case where during the 2D display, the distance measured by the distance measuring section is within the predetermined range for a time of less than the predetermined length of time. Such a configuration allows the user to appropriately recognize a visible object in an image all the time. Therefore, when the display device is mounted to an in-vehicle electronic mirror, hindrance to user's driving is reliably avoided.

An electronic mirror in accordance with Aspect 5 of the present invention is configured to include: a display device as described in any one of the above Aspects 1 to 4; and an image pickup section 20 for capturing an image of a front side, a rear side opposite to the front side, a right rear side, or a left rear side of a vehicle, and outputting the image thus captured to the display device.

The above configuration allows the driver driving the vehicle to avoid hindrance to the driving.

A display device control method in accordance with Aspect 6 of the present invention is a method for controlling a display device including a display section capable of switching between 2D display and 3D display, the 3D display being carried out by a parallax barrier method, the method including the steps of: measuring a distance from eyes of a user (driver) to a display screen of the display section; and switching display from the 3D display to the 2D display in a case where the distance measured in the step of measuring the distance is outside a predetermined range. The above configuration produces an effect similar to that of the display device in accordance with the above Aspect 1 of the present invention.

The steps of the display method as described in Aspect 6 of the present invention may be each realized by a computer.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

10 image display device (display section
20 image pickup section
30 image control device
30a image control device
31 display switching determining section
32 output image generating section
33 depth adjusting section
40 distance measuring device
60 both eyes
101, 101A, 101B, 101C, 102 electronic mirror
200 image data
201, 202 viewing angle range

1. A display device comprising:
a display section capable of switching between 2D display and 3D display, the 3D display being carried out by a parallax barrier method;
a distance measuring section for measuring a distance from an eye of a user to a display screen of the display section; and
a display switching section for switching display from the 3D display to the 2D display in a case where the distance measured by the distance measuring section is outside a predetermined range.

2. The display device as set forth in claim 1, further comprising:
an image generating section for generating right eye pixel data and left eye pixel data from an image,
the predetermined range having a minimum or maximum value which indicates a distance at which a right eye of the user starts recognizing the left eye pixel data or at which a left eye of the user starts recognizing the right eye pixel data.

3. The display device as set forth in claim 2, wherein:
the image generating section generates the image such that (i) the image has a small depth in a case where during the 3D display, the distance measured by the distance measuring section is within the predetermined range and larger than a preset value and (ii) the image has a large depth in a case where during the 3D display, the distance measured by the distance measuring section is within the predetermined range and smaller than the preset value.

4. The display device as set forth in claim 1, wherein:
the display switching section does not switch the 2D display to the 3D display in a case where during the 2D display, the distance measured by the distance measuring section is within the predetermined range for a time of less than a predetermined length of time.

5. An electronic mirror comprising:
a display device as recited in claim 1; and
an image pickup section for capturing an image of a front side, a rear side opposite to the front side, a right rear side, or a left rear side of a vehicle, and outputting the image thus captured to the display device.

6. A method for controlling a display device including a display section capable of switching between 2D display and 3D display, the 3D display being carried out by a parallax barrier method, said method comprising the steps of:
measuring a distance from an eye of a user to a display screen of the display section; and
switching display from the 3D display to the 2D display in a case where the distance measured in the step of measuring the distance is outside a predetermined range.
